(19) United States
(12) Patent Application Publication
(10) Pub. No.: US 2020/0167756 A1
(43) Pub. Date: May 28, 2020

(54) HYBRIDIZED CRYPTOCURRENCY AND REGULATED CURRENCY STRUCTURE

(71) Applicant: INTERNATIONAL BUSINESS MACHINES CORPORATION, Armonk, NY (US)

(72) Inventors: Aaron K. Baughman, Silver Spring, MD (US); Barry Michael Graham, Silver Spring, MD (US); Craig M. Trim, Ventura, CA (US)

(21) Appl. No.: 16/202,537

(22) Filed: Nov. 28, 2018

(51) Int. Cl. G06Q 20/22; G06Q 20/38; G06Q 20/06; G06Q 20/40

(52) U.S. Cl. CPC G06Q 20/227; G06Q 20/389; G06Q 20/3829; G06Q 2220/00; G06Q 20/4016; G06Q 20/381; G06Q 20/065

(57) ABSTRACT

Aspects predict an amount of cryptocurrency activity that is likely attributed to a vendor within blockchain data of the cryptocurrency as a function of an amount of market activity by the vendor in a conventional currency and an exchange rate between the cryptocurrency and a conventional currency; determine an amount of cryptocurrency activity attributed to the vendor within the cryptocurrency blockchain data; and determine a risk weighting for the cryptocurrency in proportion to a difference between the predicted amount of cryptocurrency activity and the determined amount of cryptocurrency activity attributed to the vendor.

### BACKGROUND

Conventional currency or fiat money is established and issued by a government in a physical, tangible form (in coin or paper) that may be physically exchanged; it may also be exchanged by transferring amounts deposited into financial accounts to other persons through electronic banking. Conventional money is without intrinsic value: value is set in a marketplace via agreement between parties engaging in exchange of the currency for other valuable currencies or services. Conventional currency values are also dependent upon the stability of the issuing government and the robustness of underlying regulations and supply policies controlled by laws, and by centralized banking authorities authorized by the government to regulate and administer the currency. Additional amounts of conventional currency can be produced by the issuing government whenever deemed necessary, and accordingly, the potential supply of a conventional currency is unlimited.

A crypto or digital currency is money or scrip which is only exchanged electronically. The first decentralized digital currency to gain large scale use is “bitcoin,” which is owned and maybe transferred through a ledger system pseudonymously and without reliance on a central authority to maintain account balances. Bitcoin acquire value through usefulness in exchange of value, this value is based on part on an underlying structure that limits the supply.

New bitcoins are slowly mined into existence by following a mutually agreed-upon set of rules. A user mining bitcoins is running a software program that searches for a solution to a very difficult math problem, the difficulty of which is precisely known. This difficulty is automatically adjusted on a predictable schedule in order that the number of solutions found globally for a given unit of time is constant (for example, six per hour). When a solution is found, the user may tell everyone of the existence of this newly found solution along with other information packaged together in what is called a “block”. The solution itself is a proof-of-work or “PoW.” It is hard to find, but easy to verify.

Blocks create a fixed amount of new bitcoins (for example, 12.5). This amount, known as the “block reward,” is an incentive for people to perform the computation work required for generating blocks. The number of bitcoins that can be “mined” in a block is reduced by a fixed percent periodically (for example, by 50% every four years). Ideally, no more than a maximum number of bitcoins (for example, 21 million) will ever exist, which may provide valuation advantages over the unlimited supply attributes of conventional currency.

Bitcoin ownership does not require set-up or maintenance of a user accounts, and no specific e-mail addresses, user-names or passwords are required to hold or spend bitcoins. Each balance is simply associated with an address and its public-private key pair. The money “belongs” to anyone who has the private key and can sign transactions with it. Moreover, the keys do not have to be registered anywhere in advance, as they are only used when required for a transaction.

Transacting parties do not need to know each other's identity to engage in a bitcoin transaction. A Bitcoin address mathematically corresponds to a public key. Each person can have many such addresses, each with its own balance, which enable anonymity of ownership, makes it very difficult to know which person owns what amount. In order to protect the privacy of a bitcoin owner, the owner can generate a new public-private key pair for each individual receiving transaction.

To guarantee that a third-party, cannot spend other people's bitcoins by creating transactions in their names, bitcoin uses public key cryptography to make and verify digital signatures. In this system, each person has one or more addresses, each with an associated pair of public and private keys that they may hold in a “wallet.” Only the user with the private key can sign a transaction to give some of their bitcoins to somebody else, but anyone can validate the signature using that user's public key. Anyone who has a public key can send money to a bitcoin address, but only a signature generated by the private key can release money from the bitcoin address.

### BRIEF SUMMARY

In one aspect of the present invention, a computer implemented method includes predicting an amount of cryptocurrency activity that is likely attributed to a vendor within blockchain data of the cryptocurrency as a function of an amount of market activity by the vendor in a conventional currency and an exchange rate between the cryptocurrency and a conventional currency; determining an amount of cryptocurrency activity attributed to the vendor within the cryptocurrency blockchain data; and determining a risk weighting for the cryptocurrency in proportion to a difference between the predicted amount of cryptocurrency activity and the determined amount of cryptocurrency activity attributed to the vendor.

In another aspect, a computer system has a hardware processor in circuit communication with a computer readable memory and a computer-readable storage medium having program instructions stored thereon. The processor executes the program instructions stored on the computer-readable storage medium via the computer readable memory and thereby predicts an amount of cryptocurrency activity that is likely attributed to a vendor within blockchain data of the cryptocurrency as a function of an amount of market activity by the vendor in a conventional currency and an exchange rate between the cryptocurrency and a conventional currency; determines an amount of cryptocurrency activity attributed to the vendor within the cryptocurrency blockchain data; and determines a risk weighting for the cryptocurrency in proportion to a difference between the predicted amount of cryptocurrency activity and the determined amount of cryptocurrency activity attributed to the vendor.

In another aspect, a computer program product has a computer-readable storage medium with computer readable program code embodied therewith. The computer readable program code includes instructions for execution which cause a processor to predict an amount of cryptocurrency activity that is likely attributed to a vendor within blockchain data of the cryptocurrency as a function of an amount of market activity by the vendor in a conventional currency and an exchange rate between the cryptocurrency and a conventional currency; determine an amount of cryptocurrency activity attributed to the vendor within the cryptocurrency blockchain data; and determine a risk weighting for the cryptocurrency in proportion to a difference between the predicted amount of cryptocurrency activity and the determined amount of cryptocurrency activity attributed to the vendor.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing environment according to an embodiment of the present invention.

FIG. 2 depicts abstraction model layers according to an embodiment of the present invention.

FIG. 3 depicts a computerized aspect according to an embodiment of the present invention.

FIG. 4 is a block diagram illustration of an embodiment of the present invention.

FIG. 5 is a block diagram illustration of another embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and be rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

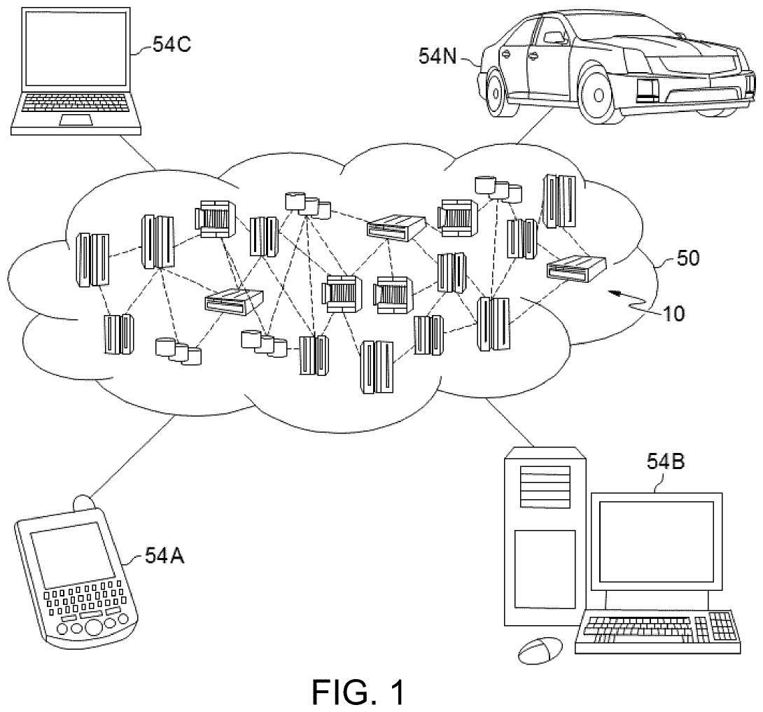

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

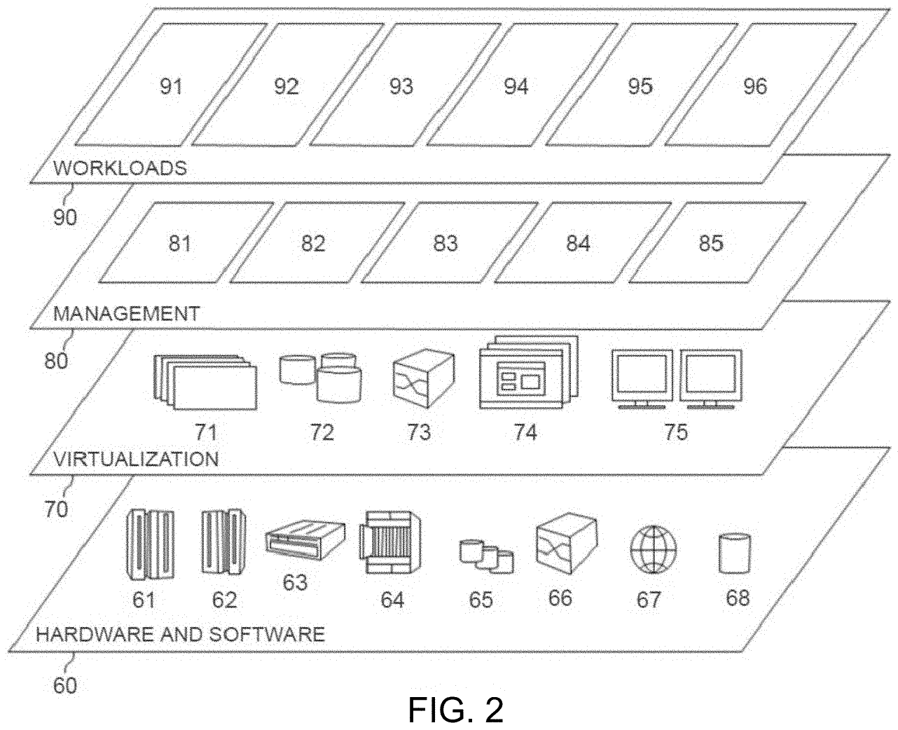

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing for a hybridized ledger for cryptocurrency and conventual currency according to aspects of the present invention 96.

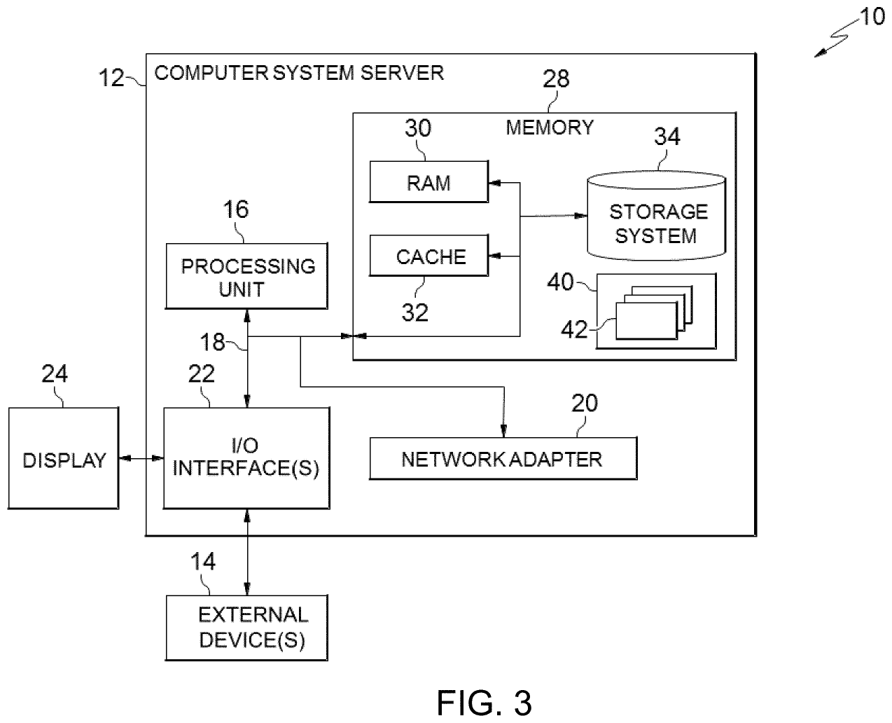

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

While cryptocurrencies are not regulated nor centralized, some users find that their transactional attributes (for example, lower transaction cost, transactional validity assurance through blockchain processes, and optional anonymity) are preferable over those of regulated, conventional currency (fiat money) for some transactions. Accordingly, the use of cryptocurrencies in place of fiat money is increasing in volume and frequency. However, values of cryptocurrency may be much more volatile relative to fiat money, experiencing larger changes over much shorter time periods (for example, in minutes or seconds), whereas standard, regulated currencies are more stable. Moreover, due to their unregulated nature and lack of backing by a governmental entity, there is some inherent risk of loss from unpredicted, large-scale downturns, or collapses, in valuation of cryptocurrency over said shorter time periods, wherein the holder does not have enough time to liquidate cryptocurrency holdings before losing substantial monetary value.

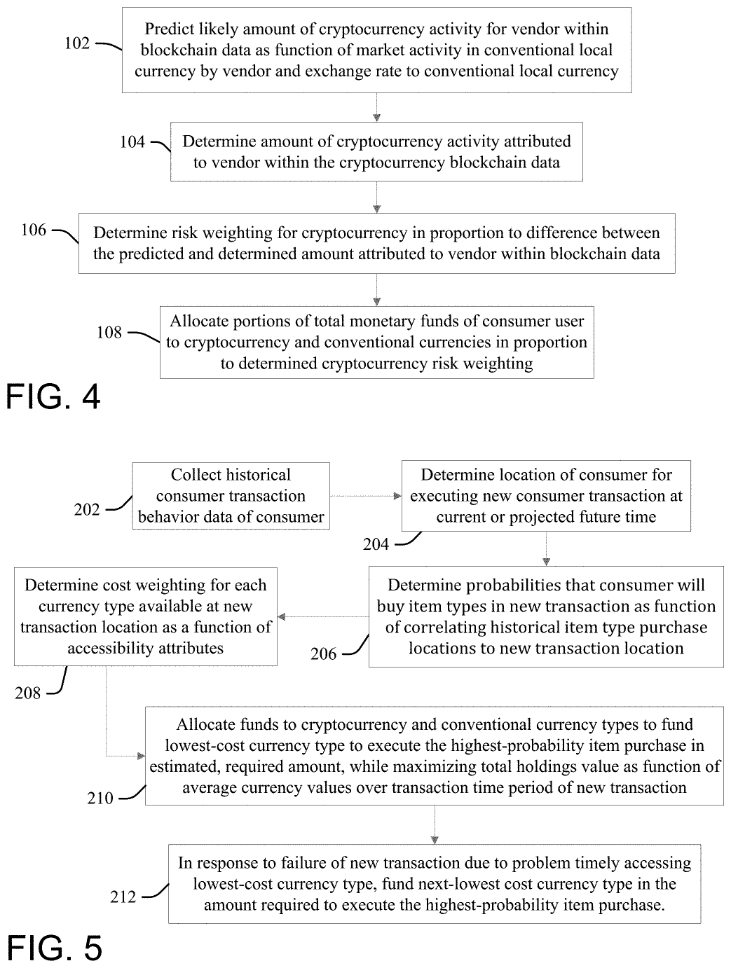

Adoption of cryptocurrency as a viable means to exchange monetary values requires users to quantify perceived or actual risk of loss in a meaningful fashion, such as accomplished by embodiment of the present invention. FIG. 4 illustrates one embodiment according to the present invention. At 102 a processor configured according to the present invention (the “configured processor”) predicts an amount of cryptocurrency activity that is likely attributed to a vendor within blockchain data of the cryptocurrency as a function of an exchange rate between the cryptocurrency and a conventional local currency of a domicile of the vendor, and an amount of market activity in the conventional local currency by the vendor. The activity metrics may be numbers of transactions, frequencies of transactions over time, amounts of the cryptocurrency, monetary value of the amounts of the cryptocurrency in the local conventional currency as a function of effective exchange rates, or combinations thereof.

More particularly, embodiments consider the type and amount of each available cryptocurrency and local or foreign conventional currency reported within market activity as input into a predictive model at 102 that predicts the likely amount of cryptocurrency held by the vendor (as represented by the blockchain activity) over a transaction time period defined by market performance and operating duration data of vendor transactions as a function of stability of each currency. More particularly, the transaction time period is defined as an average time period from the time of initiation of a transaction for goods or services provided by the vendor to the time at which the vendor realizes the monetary value of payment to the vendor in satisfaction of providing said goods or services. Examples include at the time of the transaction defined by “date:minute:second” data (for example, the time of an in-store purchase of electronic consumer goods, or apparel): end-of-business day (for example, in a purchase of shares of a mutual fund the price is not set until trading closes, generally at 4:00 PM in the time zone of the location of the transaction, where the closing share price is set as the share price for the transaction), and the amount of currency required is established by the value of the currency at that time; and a multi-day time period, for example, at the end of a three-day period specified by statute to allow a consumer to cancel a specific purchase, or the end of a seven (7) day period required to complete purchased services, wherein the terms of the transaction delay payment of the majority of the quoted price until the services are deemed satisfactorily rendered by the customer at the end of said multi-day period, and sometimes plus additional day(s) specified by law wherein acceptable of the offered goods or services is deemed statutorily complete.

The predicted amounts are determined as a function of average value of the transaction determined from price index data, and the average value of the different currency options determined from currency exchange rates, over the transaction time period. For example, for instant or one-day transactions, conventional currency values generally remain fixed, as currency exchange rates set by central banking authorities typically cannot change more frequently than daily; in contrast, cryptocurrency value may vary greatly over any 24-hour time period. For longer transaction time periods (more than one day), the moving average of each currency option is determined by applicable exchange rates. By valuing the respective currencies as the average of their values over the transaction time periods, the configured processor predicts the amounts that the vendor will hold in each type of currency as a function of the risk of valuation changes within each: for example, if regulations required the vendor to have cash reserves on hand inclusive of receivables to meet a threshold “X” at the end of the average transaction time in any given type of currency, then the configured processor predicts that the vendor will not hold less than “X plus Y” in cryptocurrency, where “Y” is the maximum drop in value of the cryptocurrency observed over the time period in historic data.

Moreover, the configured processor may predict at 102 that the vendor will not hold less than “X plus Y” over the average vendor transaction time period, due to the much lower (or zero) transaction costs for the vendor in cryptocurrency transactions, relative to the transactional fees levied by credit card and other banking entities in settling transactions paid by conventional currency. Further, the portions of amounts of foreign currency holdings within total conventional currencies may be set relative to a local (national) currency of the transaction or vendor location to reflect exchange fees required to convert said foreign currency to the local currency.

Thus, embodiments may predict at 102 that a higher percentage or amount of local conventional currency is associated with most frequency with high-value transactions over longer time periods, may reflect a high risk premium placed on acceptance of the cryptocurrency in consideration for the high-value transaction by the vendor (due to likely or historic fluctuations in value) that may expose the vendor to missing thresholds for currency holding values at any given time.

At 104 the configured processor determines an amount of cryptocurrency activity actually attributed to the vendor within the cryptocurrency blockchain data.

At 106 the configured processor determines a risk weighting for the cryptocurrency as a function of (in proportion to) a difference between the predicted and determined activity metrics attributed to the vendor within the blockchain data.

At 108 the configured processor allocates portions of total monetary funds of user to each of the cryptocurrency and the conventional local currency in proportion to the cryptocurrency risk weighting.

Bitcoin and other cryptocurrencies use a public ledger blockchain to record and publish transactions. To transfer cryptocurrency to a recipient an owner (sender) adds a unique email address of the recipient and the amount of the cryptocurrency to transfer to a “transaction” message that the owner signs with her private key, wherein the owner's public key is broadcast for signature verification, and wherein the transaction is also broadcast on a cryptocurrency network structure. Thus, looking at this transaction from the outside, anyone who knows that these addresses belong to owner/sender and recipient can see that owner/sender has agreed to transfer the cryptocurrency amount to recipient, wherein the validity is ensured by the confidentiality of the owner/sender private key used to sign the transaction. Losing control and confidentially of the private key exposes the owner to loss of remaining cryptocurrency, as this would enable another to sign transactions in the owner's name, and thereby removing the cryptocurrency from her control.

The validity of bitcoin and other cryptocurrency transactions relies substantially on a “blockchain” mechanism. A blockchain is a constantly growing chain of blocks that each contain a record of one or more transactions, and is collectively maintained by all computers in the cryptocurrency system (wherein each generally has a full copy), and wherein the blockchain is fixed and signed with a unique hash code. To be accepted in the chain, each transaction block must be valid and must be signed with its own unique “proof of work” hash code.

For example, in the case of a requested bitcoin transaction, in response to verifying that the owner/sender has enough bitcoin to satisfy the transaction, a bitcoin miner bundles the pending transaction data with data from other unrecorded transactions, the last block of transactions recorded in a public ledger, and a random number generally referred to as a “nonce.” The miner uses a hash function to generate a unique, hash code representation “fingerprint” of the bundled data values inclusive (thus, as a function of the random numbers) of the nonce, and thereby generates a “hashed block” from the bundled data values as a function of the hash code fingerprint, which is recorded in the public ledger as the new, last block of transactions recorded in the public ledger.

Thus, when the recipient sees that the transaction has been included in the blockchain, the recipient has notice that the transaction by the previous owner/sender has been accepted by the computers in the network and is permanently recorded. The owner/sender is prevented from creating a second transaction with the same bitcoin (“reselling”) by the hash code fingerprint securing the blockchain record that is published in a public ledger, as it would be computationally unfeasible, and therefore effectively impossible, to revise the secured, public ledger blockchain data.

Public ledger blockchain data comprises and presents a variety of information useful in defined vendor activity, including amount, value, time, source, transaction fees, product or service bought from the vendor, etc. The embodiments of FIG. 4 use this information as the basis for defining an acceptable risk factor useful in autonomously and automatically allocating user funds between cryptocurrency and conventional currencies. Thus, at 104 the configured processor determines the amount of cryptocurrency actually attributed to the vendor within the cryptocurrency blockchain data by totaling the cryptocurrency amounts within each of the blockchain blocks that are identified as owned by (or “relayed by”) the vendor. If the vendor is not explicitly identified by the block “relayed by” fields, then the configured processor may consider other data within the blockchain data that is uniquely associated to the vendor, such as unique, regional-based internet protocol (IP) addresses that are associated to the vendor, and attribute “relayed by” activity associated to said IP addresses to the vendor.

Each sale of products or services by a vendor in exchange for cryptocurrency is recorded within blockchain data. Additional financial transactions associated with the sale of products or services by the vendor in the local conventional currency are recorded within public ledgers related to regulated currencies (for example, reported taxes for withholding, sales, corporate profits and other public tax records; quarterly and yearly earnings, profits, expenses and revenue disclosed by publicly-traded corporations in financial reports; sales targets, gross sales, etc.).

Thus, the risk weighting determined at 106 generally increases in proportion to the amount that the amount of cryptocurrency determined as actually attributed to the vendor at 104 is less than the amount predicted at 102: reflecting that lower holdings or usage indicates that the vendor has identified an additional likely risk of loss to the cryptocurrency, beyond that determined by the public data considered in making the prediction amounts at 102. The risk weighting determined at 106 generally decreases in proportion to the amount that the amount of cryptocurrency determined as actually attributed to the vendor at 104 is greater than the amount predicted at 102: reflecting that higher holdings or usage indicates that the vendor anticipates an increase in value of the cryptocurrency over this period, probably based on other information beyond that determined by the public data considered in making the prediction amounts at 102.

FIG. 5 illustrates another embodiment of the present invention. At 202 a processor configured according to the present invention (the “configured processor”) collects historical consumer transaction behavior data of the user from private cryptocurrency ledgers and conventional local currency accounts of the user that includes specific types of items (products or services) purchased, purchase prices and types of currencies used, locations of the purchase transactions, and transaction periods (the times required to complete each transaction from inception to satisfaction by payment by the consumer user).

At 204 the configured processor determines a location of the consumer (user) for executing a new consumer transaction at a current, or a projected future, time. For example, the configured processor determines a current location for the new consumer transaction in response to initiation of a purchase transaction by the user on-line, or within a physical store; or the location of the consumer at a future calendar appointment date and time for services, which may be a current national location (for example, “Take car in for oil changes @ 10:00 AM on June 1, @ Joe's Garage, 1234 Main St, Anytown, USA”, wherein the consumer lives in the USA) or a different national location relative to the current location of the user (for example, “Check in at Best Hostel, Tourist Town, Other Foreign Country, July 2”).

At 206 the configured processor determines probabilities that consumer will buy each of different ones of the specific types of items in the new transaction as a function of correlating the locations of historical item purchases of the item types to the location of the new transaction. For example, in response to determining that the location of the new transaction is a foreign country “Z” to which the consumer will be travelling in one week, the configured processor determines (assigns) higher probabilities for item types previously purchased by the consumer, or by other consumers sharing demographic data with the consumer (similar annual income, advance degree, employment occupation, etc.) within country “Z” or a common economic zone to which country “Z” belongs (for example, European Union, North American Free Trade Area, etc.), and in proportion to the number of transactions or total currency values spent on said item types (for example, a highest probability to consumer electronics based on gross spending amounts, a next highest probability to apparel, etc., a third-highest probability to multi-day cruise packages, etc.

Some embodiments determine probabilities at 206 as a function of normalized distributions of prices per each item type and learned parameters of a Poison distribution. Still other statistical approaches will be apparent to one skilled in the art.

At 208 the configured processor determines cost weightings to each of the currency types as a function of accessibility attributes at the new transaction location. For example, higher cost weightings are assigned to fiat money, whether local or foreign currency, in inverse proportion to distances to automated teller machines (ATM) defined as a typical or average walking distance that the consumer is willing to travel to an ATM from the transaction location (for example, per square kilometer, within two miles, etc.), or distribution density per square area metric defined as a function of the walking distance, as the higher the distance or lower the distribution the higher the difficulty in finding and using an ATM to acquire fiat money. Foreign currency accounts (for example, the home currency of the consumer travelling to a different nation) are assigned higher cost weights to reflect exchange fees to convert to the needed currency used in the new transaction location. Cryptocurrency cost weightings may default to the lowest cost weighting values, due to the low (or non-existent) time and transactional fees or costs associated with their use, relative to the transactional fees of any of the available conventional currencies.

At 210 the configured processor allocates portions of total monetary funds of consumer user to cryptocurrency and conventional currency types to fund the lowest-cost currency type to execute the highest-probability item purchase (determined at 206) in an amount required in the historic data acquired at 202 while maximizing total holdings value as a function of the average value of the different currency options determined from currency exchange rates over a transaction time period extending from the time of the new transaction (as estimated from the historic consumer transaction behavior data). In some embodiments the maximizing total holdings value is maximized at 210 as a function of the cryptocurrency risk weighting determined at 106 of FIG. 4, as described above.

For example, at 210 the configured processor allocates to the lowest-cost currency type (cryptocurrency coins within a private cryptocurrency ledger of the consumer,) a (first) amount of total available funds that is less the average amount spent by the consumer for a highest-probability item purchase of apparel at the location (duty-free glassware purchases, in a foreign country location that produces high-quality glassware) by an anticipated appreciation amount in the cryptocurrency that is less than an expected (predicted) increase value in the cryptocurrency between a current time and the transaction time, as weighted by the cryptocurrency risk weighting determined at 106 of FIG. 4, as described above. The cryptocurrency coins are determined at 208 to have the lowest weighted cost as a function having no transaction purchase fees, and a best availability (accepted by all likely vendors at the location) relative to fiat money that has distance costs to ATM's.

Continuing the present example, a second amount or portion of the total available funds is allocated at 210 to a local conventional currency account that is determined necessary to meet bill-paying needs and maintain minimum balances to earn banking interest that will off-set banking fees associated with local conventional currency account during the time period inclusive of the new transaction time.

A third amount or portion of the total available funds is allocated at 210 to a foreign conventional currency of the location of the new transaction. This allocation minimizes the exchange costs in funding, and later removing funds from foreign conventional currency account, while ensuring the consumer has enough foreign conventional currency available to execute other transactions (lodging, travel, dining, etc.) historically required at the transaction location.

The remainder (fourth) amount or portion of the total available funds is allocated at 210 at rate of 80% to the cryptocurrency coins and 20% to the local conventional currency account, in response to a determination that the cryptocurrency coins are likely to earn more value through appreciation than the interest otherwise earned within the local conventional currency account, but wherein 20% is retained in the local conventional currency account to match a current cryptocurrency risk weighting of 20% (determined at 106 of FIG. 4, as described above).

At 212, in response to determining that the consumer fails to execute the new transaction (for example, due to problems in accessing or transferring the lowest-cost currency type to prior to elapse of a maximum time allowed to execute the highest-probability item purchase), wherein the new transaction fails, the configured processor dynamically adjusts the allocations made at 210 to select and fund a next-lowest cost currency type in the amount required in the historic data to execute the highest-probability item purchase. For example, in determining a failure to successfully complete a transaction from the lowest-cost cryptocurrency (wherein the vendor cannot accept the cryptocurrency due to policies recently enacted by a management entity), the lowest cost option of remaining, available conventional currency options is selected and funded for a subsequent transaction attempt. The feedback process at 212 updates an accessibility model defined by the allocations at 210 in an active, learning process, for use in future iterations of the process of FIG. 5.

Aspects of the present invention utilizes both the public and private ledger data to perform a complex monetary analysis that provides for hybridized holdings of monetary value in a dynamic combinational usage of fiat money and cryptocurrency, enabling higher earnings yields, reduced currency exchange costs and better (quicker and maximized) monetary value availably for real-time purchases or other transactions, relative to conventional fiat money accounts and cryptocurrency holdings management. The seamless type of banking executed by embodiments of the present invention provide for an improved user experience while also increasing buying power and ability, including in mobile applications.

Mobile banking has greatly increased the reach of monetary services around the world. Robust and nimble mobile banking platforms enable micro-pattern currency trading, a computerized high-frequency trading (HFT) driven by algorithm and characterized by high speeds, high turnover rates, and high order-to-trade ratios that leverages high-frequency financial data and electronic trading tools, wherein strategies are carried out by computers to move users in and out of positions in seconds or fractions of a second.

Fiat money can be retrieved from ATM's, cash-back systems, exchanged through conventional, commercial mobile banking platforms. Cryptocurrency transfers generally occur within their own platforms, and interface with mobile banking platforms to move (transform) value between the two, different currency platforms. However, determining which of available cryptocurrency and conventional currency options best meets the needs or objectives of a user may be confusing, difficult, or even intractable, including as a function of vast differences in their relative value stability. For example, selecting types and amounts of fiat money that should be maintained in a physical wallet or mobile banking account to best meet a user's (expected) needs or objectives may depend on the types and national location of vendors, typical user spending patterns, and associated electronic business transactional costs. Adding additional complexity or confusion to the decision process are the rapidly fluctuating or dynamic exchange rates typically occurring between fiat money and cryptocurrency. For example, the effective buying power realized in exchanging between traditional currency and cryptocurrency to satisfy consideration in a given exchange may vary more rapidly than that realized in an exchange between two different traditional (national) currencies.

Moreover, relative to traditional currency values that are controlled by centralized banking regulators, cryptocurrency may experience much larger value fluctuations, on a much smaller time period basis: for example, over minutes or a micro-trading quotation time period, relative to a daily fiat money exchange quotation. Thus, due to rapidly fluctuating exchange rates and net effective amounts of associated transaction fees, users are generally unable under the prior art to determine the best times and amounts of monetary value to convert between conventional currency and cryptocurrency options, in order to realize a highest overall, composite value derived from a combination of different holdings in cryptocurrency and fiat money accounts.

In contrast, embodiments according to the present invention automatically and dynamically change the mixture of cryptocurrency and conventional currency holdings as a function of user or workplace national residence and location data, monitoring user spending habits, and projecting impacts from news and world events on cryptocurrency and conventional currency values.

Embodiments provide advantages over the prior art by enabling users to effectively predict and determine different relative amounts that they should hold in hard cash and cryptocurrency in order to maximize overall, composite holdings monetary values while meeting anticipated needs and personalized risk tolerance as a function of exchange rate fluctuations, micro-trading behaviors, and perceived cryptocurrency reliability (as a function of blockchain mechanisms, etc.).

The terminology used herein is for describing aspects only and is not intended to be limiting of the invention. As used herein, singular forms “a”, “an”, and “the” are intended to include the plural forms as well, unless the context clearly indicates otherwise. It will be further understood that the terms “include” and “including” when used in the specification specify the presence of stated features, integers, steps, operations, elements, and/or groups thereof. Certain examples and elements described in the present specification, including in the claims, and as illustrated in the figures, may be distinguished, or otherwise identified from others by unique adjectives (e.g. a “first” element distinguished from a “second” or “third” of a plurality of elements, a “primary” distinguished from a “secondary” one or “another” item, etc.) Such identifying adjectives are generally used to reduce confusion or uncertainty and are not to be construed to limit the claims to any specific illustrated element or embodiment, or to imply and precedence, ordering, or ranking of any certain elements, limitations, or process steps.

The descriptions of the various embodiments of the present invention have been presented for the purposes of illustration but are not intended to be exhaustive or limited to the embodiments disclosed. Many modifications and variations will be apparent to those of ordinary skill in the art without departing for the scope and spirit of the described embodiments. The terminology used herein was chosen to best explain the principles of the embodiments, the practical applications or technical improvement over technologies found in the marketplace, or to enable others of ordinary skill in the art to understand the embodiments disclosed herein.

What is claimed is:

1. A computer-implemented method, comprising:
predicting an amount of cryptocurrency activity that is likely attributed to a vendor within blockchain data of the cryptocurrency as a function of an amount of market activity by the vendor in a conventional currency and an exchange rate between the cryptocurrency and a conventional currency;
determining an amount of cryptocurrency activity attributed to the vendor within the cryptocurrency blockchain data; and
determining a risk weighting for the cryptocurrency in proportion to a difference between the predicted amount of cryptocurrency activity and the determined amount of cryptocurrency activity attributed to the vendor.

2. The method of claim 1, wherein the conventional currency is one of a plurality of different conventional currencies that are available to a consumer, further comprising:
allocating portions of total monetary funds of user to each of the cryptocurrency and the plurality of conventional currencies in proportion to the cryptocurrency risk weighting.

3. The method of claim 2, further comprising:
collecting historical transaction behavior data of the consumer comprising types of items purchased by the consumer and locations of item purchase by the consumer; and
allocating a first portion of the total monetary funds to a lowest cost one of the cryptocurrency and the plurality of conventional currencies in a historic amount that is determined from the consumer historical transaction behavior data as required to execute a highest-probability item purchase at a location of a new item purchase transaction.

4. The method of claim 3, further comprising:
determining a cost weighting for one of the conventional currencies in inverse proportion to an automated teller machine distance metric that is selected from the group consisting of a distance from the location of the new item purchase transaction to a location of an automated teller machine, and distribution density of automated teller machines within a square area defined as a function of a maximum walking distance for the consumer.

5. The method of claim 3, further comprising:
allocating a fractional portion of a remainder of unallocated funds of the total monetary funds to the cryptocurrency in an amount that is in inverse proportion to the determined risk weighting for the cryptocurrency.

6. The method of claim 3, further comprising:
in response to determining that the consumer fails to execute the highest-probability item purchase as function of untimely access to the lowest cost one of the cryptocurrency and the plurality of conventional currencies, reallocating the first portion of the total monetary funds in the historic required amount to a next-lowest cost one of the cryptocurrency and the plurality of conventional currencies for a subsequent transaction attempt.

7. The method of claim 1, further comprising:
integrating computer-readable program code into a computer system comprising a processor, a computer readable memory in circuit communication with the processor, and a computer readable storage medium in circuit communication with the processor; and
wherein the processor executes program code instructions stored on the computer-readable storage medium via the computer readable memory and thereby performs the predicting the amount of cryptocurrency activity that is likely attributed to the vendor, the determining the amount of cryptocurrency activity attributed to the vendor within the cryptocurrency blockchain data, and the determining the risk weighting for the cryptocurrency.

8. The method of claim 7, wherein the computer-readable program code is provided as a service in a cloud environment.

9. A computer system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
predicts an amount of cryptocurrency activity that is likely attributed to a vendor within blockchain data of the cryptocurrency as a function of an amount of market activity by the vendor in a conventional currency and an exchange rate between the cryptocurrency and a conventional currency;
determines an amount of cryptocurrency activity attributed to the vendor within the cryptocurrency blockchain data; and
determines a risk weighting for the cryptocurrency in proportion to a difference between the predicted amount of cryptocurrency activity and the determined amount of cryptocurrency activity attributed to the vendor.

10. The system of claim 9, wherein the conventional currency is one of a plurality of different conventional currencies that are available to a consumer, and wherein the processor executes the program instructions stored on the computer-readable storage medium via the computer readable memory and thereby:
allocates portions of total monetary funds of user to each of the cryptocurrency and the plurality of conventional currencies in proportion to the cryptocurrency risk weighting.

11. The system of claim 10, wherein the processor executes the program instructions stored on the computer-readable storage medium via the computer readable memory and thereby:
collects historical transaction behavior data of the consumer comprising types of items purchased by the consumer and locations of item purchase by the consumer; and
allocates a first portion of the total monetary funds to a lowest cost one of the cryptocurrency and the plurality of conventional currencies in a historic amount that is determined from the consumer historical transaction behavior data as required to execute a highest-probability item purchase at a location of a new item purchase transaction.

12. The system of claim 11, wherein the processor executes the program instructions stored on the computer-readable storage medium via the computer readable memory and thereby:
determines a cost weighting for one of the conventional currencies in inverse proportion to an automated teller machine distance metric that is selected from the group consisting of a distance from the location of the new item purchase transaction to a location of an automated teller machine, and distribution density of automated teller machines within a square area defined as a function of a maximum walking distance for the consumer.

13. The system of claim 11, wherein the processor executes the program instructions stored on the computer-readable storage medium via the computer readable memory and thereby:
allocates a fractional portion of a remainder of unallocated funds of the total monetary funds to the cryptocurrency in an amount that is in inverse proportion to the determined risk weighting for the cryptocurrency.

14. The system of claim 11, wherein the processor executes the program instructions stored on the computer-readable storage medium via the computer readable memory and thereby:
in response to determining that the consumer fails to execute the highest-probability item purchase as function of untimely access to the lowest cost one of the cryptocurrency and the plurality of conventional currencies, reallocates the first portion of the total monetary funds in the historic required amount to a next-lowest cost one of the cryptocurrency and the plurality of conventional currencies for a subsequent transaction attempt.

15. A computer program product, comprising:
a computer readable storage medium having computer readable program code embodied therewith, the computer readable program code comprising instructions for execution by a processor that cause the processor to:
predict an amount of cryptocurrency activity that is likely attributed to a vendor within blockchain data of the cryptocurrency as a function of an amount of market activity by the vendor in a conventional currency and an exchange rate between the cryptocurrency and a conventional currency;
determine an amount of cryptocurrency activity attributed to the vendor within the cryptocurrency blockchain data; and
determine a risk weighting for the cryptocurrency in proportion to a difference between the predicted amount of cryptocurrency activity and the determined amount of cryptocurrency activity attributed to the vendor.

16. The computer program product of claim 15, wherein the conventional currency is one of a plurality of different conventional currencies that are available to a consumer, and wherein the computer readable program code instructions for execution by the processor further cause the processor to:
allocate portions of total monetary funds of user to each of the cryptocurrency and the plurality of conventional currencies in proportion to the cryptocurrency risk weighting.

17. The computer program product of claim 16, wherein the computer readable program code instructions for execution by the processor further cause the processor to:
collect historical transaction behavior data of the consumer comprising types of items purchased by the consumer and locations of item purchase by the consumer; and
allocate a first portion of the total monetary funds to a lowest cost one of the cryptocurrency and the plurality of conventional currencies in a historic amount that is determined from the consumer historical transaction behavior data as required to execute a highest-probability item purchase at a location of a new item purchase transaction.

18. The computer program product of claim 17, wherein the computer readable program code instructions for execution by the processor further cause the processor to:
determine a cost weighting for one of the conventional currencies in inverse proportion to an automated teller machine distance metric that is selected from the group consisting of a distance from the location of the new item purchase transaction to a location of an automated teller machine, and distribution density of automated teller machines within a square area defined as a function of a maximum walking distance for the consumer.

19. The computer program product of claim 17, wherein the computer readable program code instructions for execution by the processor further cause the processor to:
allocate a fractional portion of a remainder of unallocated funds of the total monetary funds to the cryptocurrency in an amount that is in inverse proportion to the determined risk weighting for the cryptocurrency.

20. The computer program product of claim 17, wherein the computer readable program code instructions for execution by the processor further cause the processor to:
in response to determining that the consumer fails to execute the highest-probability item purchase as function of untimely access to the lowest cost one of the cryptocurrency and the plurality of conventional currencies, reallocate the first portion of the total monetary funds in the historic required amount to a next-lowest cost one of the cryptocurrency and the plurality of conventional currencies for a subsequent transaction attempt.
